(19) United States
(12) Patent Application Publication
(10) Pub. No.: US 2023/0185879 A1
(43) Pub. Date: Jun. 15, 2023

(54) Time Series Model Update

(71) Applicant: International Business Machines Corporation, Armonk, NY (US)

(72) Inventors: Si Er Han, Glenmont, NY (US); Xue Ying Zhang, Xi'an (CN); Jing Xu, Xi'an (CN); Xiao Ming Ma, Xi'an (CN); Ji Hui Yang, Beijing (CN)

(21) Appl. No.: 17/644,350

(22) Filed: Dec. 15, 2021

(51) Int. Cl. G06K 9/62; G06N 20/00

(52) U.S. Cl. CPC G06K 9/6228; G06K 9/6261; G06K 9/6262; G06N 20/00

(57) ABSTRACT

A computer implemented technique including: splitting data of a historical time series data set into subsets; updating a time series model by backwards data selection to obtain an interim version of the time series model; exploring pattern changes in the new data to obtain new predictors of pattern change; and updating the interim version of the time series model by applying the new predictors of pattern change to obtain an updated version of the time series model.

### BACKGROUND

The present invention relates generally to the field of time series models that are used in various types of computing, such as machine learning.

A time series data is a sequence of data points, measured typically at successive points in time spaced at uniform time intervals. Examples of time series are the daily resource utilization monitored from an application server which handles an important online business. Based on the historical data, time series models can be built, which will used to forecast the upcoming data points. After some time, when new time series data are coming, observers may find that the observed data may be different from the predicted values. That is, the predictions are not accurate. Typically, computer code is used to combine the old data and new data together, and rebuild the time series model, in the hope that the rebuilt model will make more accurate predictions of values in the time series on a going-forward basis.

### SUMMARY

According to an aspect of the present invention, there is a method, computer program product and/or system that performs the following operations (not necessarily in the following order): (i) receiving an original version of a time series model; (ii) receiving a historical time series data set including historically observed time series data; (iii) receiving a new data set including new time series data; (iv) splitting data of the historical time series data set into subsets; (v) updating the original version of the time series model by backwards data selection to obtain an interim version of the time series model; (vi) exploring pattern changes in the new data to obtain new predictors of pattern change; and (vii) updating the interim version of the time series model by applying the new predictors of pattern change to obtain an updated version of the time series model.

### BRIEF DESCRIPTION OF THE DRAWINGS

FIG. 1 is a block diagram view of a first embodiment of a system according to the present invention;

FIG. 2 is a flowchart showing a first embodiment method performed, at least in part, by the first embodiment system;

FIG. 3 is a block diagram showing a machine logic (for example, software) portion of the first embodiment system; and

FIG. 4 is a diagram helpful in understanding various embodiments of the present invention.

### DETAILED DESCRIPTION

This Detailed Description section is divided into the following subsections: (i) The Hardware and Software Environment; (ii) Example Embodiment; and (iii) Definitions.

### I. The Hardware and Software Environment

The present invention may be a system, a method, and/or a computer program product at any possible technical detail level of integration. The computer program product may include a computer readable storage medium (or media) having computer readable program instructions thereon for causing a processor to carry out aspects of the present invention. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (for example, light pulses passing through a fiber-optic cable), or electrical signals transmitted through a wire.

A “storage device” is hereby defined to be anything made or adapted to store computer code in a manner so that the computer code can be accessed by a computer processor. A storage device typically includes a storage medium, which is the material in, or on, which the data of the computer code is stored. A single “storage device” may have: (i) multiple discrete portions that are spaced apart, or distributed (for example, a set of six solid state storage devices respectively located in six laptop computers that collectively store a single computer program); and/or (ii) may use multiple storage media (for example, a set of computer code that is partially stored in as magnetic domains in a computer's non-volatile storage and partially stored in a set of semiconductor switches in the computer's volatile memory). The term “storage medium” should be construed to cover situations where multiple different types of storage media are used.

Computer readable program instructions described herein can be downloaded to respective computing/processing devices from a computer readable storage medium or to an external computer or external storage device via a network, for example, the internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

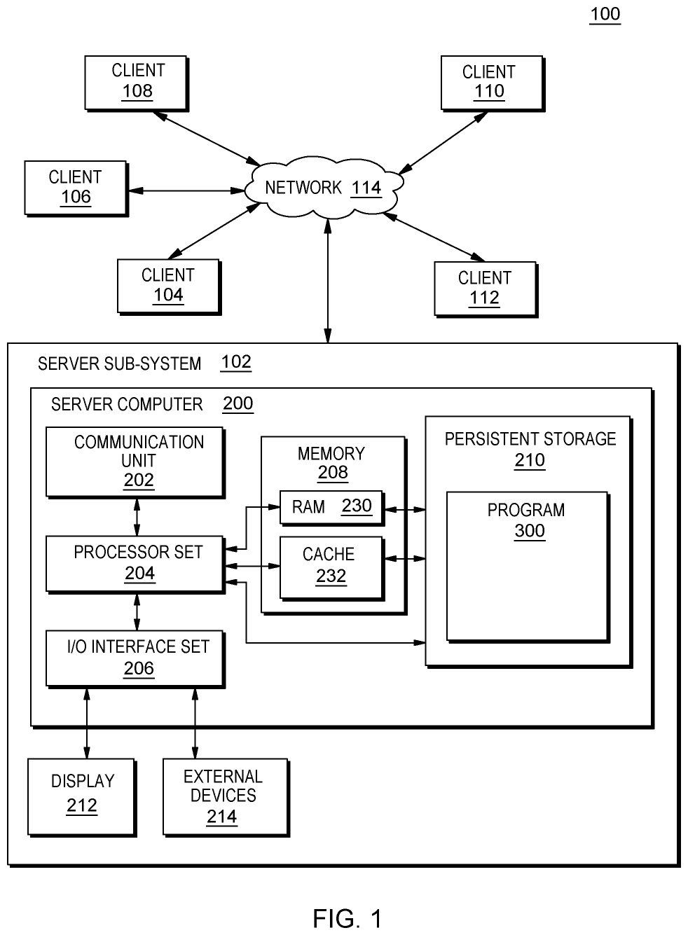

As shown in FIG. 1, networked computers system 100 is an embodiment of a hardware and software environment for use with various embodiments of the present invention. Networked computers system 100 includes: server subsystem 102 (sometimes herein referred to, more simply, as subsystem 102); client subsystems 104, 106, 108, 110, 112; and communication network 114. Server subsystem 102 includes: server computer 200; communication unit 202; processor set 204; input/output (I/O) interface set 206; memory 208; persistent storage 210; display 212; external device(s) 214; random access memory (RAM) 230; cache 232; and program 300.

Subsystem 102 may be a laptop computer, tablet computer, netbook computer, personal computer (PC), a desktop computer, a personal digital assistant (PDA), a smart phone, or any other type of computer (see definition of “computer” in Definitions section, below). Program 300 is a collection of machine readable instructions and/or data that is used to create, manage and control certain software functions that will be discussed in detail, below, in the Example Embodiment subsection of this Detailed Description section.

Subsystem 102 is capable of communicating with other computer subsystems via communication network 114. Network 114 can be, for example, a local area network (LAN), a wide area network (WAN) such as the internet, or a combination of the two, and can include wired, wireless, or fiber optic connections. In general, network 114 can be any combination of connections and protocols that will support communications between server and client subsystems.

Subsystem 102 is shown as a block diagram with many double arrows. These double arrows (no separate reference numerals) represent a communications fabric, which provides communications between various components of subsystem 102. This communications fabric can be implemented with any architecture designed for passing data and/or control information between processors (such as microprocessors, communications and network processors, etc.), system memory, peripheral devices, and any other hardware components within a computer system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for subsystem 102; and/or (ii) devices external to subsystem 102 may be able to provide memory for subsystem 102. Both memory 208 and persistent storage 210: (i) store data in a manner that is less transient than a signal in transit; and (ii) store data on a tangible medium (such as magnetic or optical domains). In this embodiment, memory 208 is volatile storage, while persistent storage 210 provides nonvolatile storage. The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202 provides for communications with other data processing systems or devices external to subsystem 102. In these examples, communications unit 202 includes one or more network interface cards. Communications unit 202 may provide communications through the use of either or both physical and wireless communications links. Any software modules discussed herein may be downloaded to a persistent storage device (such as persistent storage 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. I/O interface set 206 also connects in data communication with display 212. Display 212 is a display device that provides a mechanism to display data to a user and may be, for example, a computer monitor or a smart phone display screen.

In this embodiment, program 300 is stored in persistent storage 210 for access and/or execution by one or more computer processors of processor set 204, usually through one or more memories of memory 208. It will be understood by those of skill in the art that program 300 may be stored in a more highly distributed manner during its run time and/or when it is not running. Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. Example Embodiment

There is a drawback in the conventional manner that time series models are updated (see discussion of conventional technology for updating time series models above in the background section. More specifically, the patterns in the very old data may be different from the new data, and when the new and old data is combined, the updated model will be affected, and likely made to be less accurate, by the very old data.

Some embodiments: (i) update the time series model using backward selection to select recent data that can predict the new data accurately; (ii) further explore the new data to identify a time point at which the patterns may change; (iii) introduce the new predictors to indicate the outliers; and/or (iv) update the time series model with selected historical data, new data and new predictors including new exogenous predictor(s) and created indicators for outlier(s).

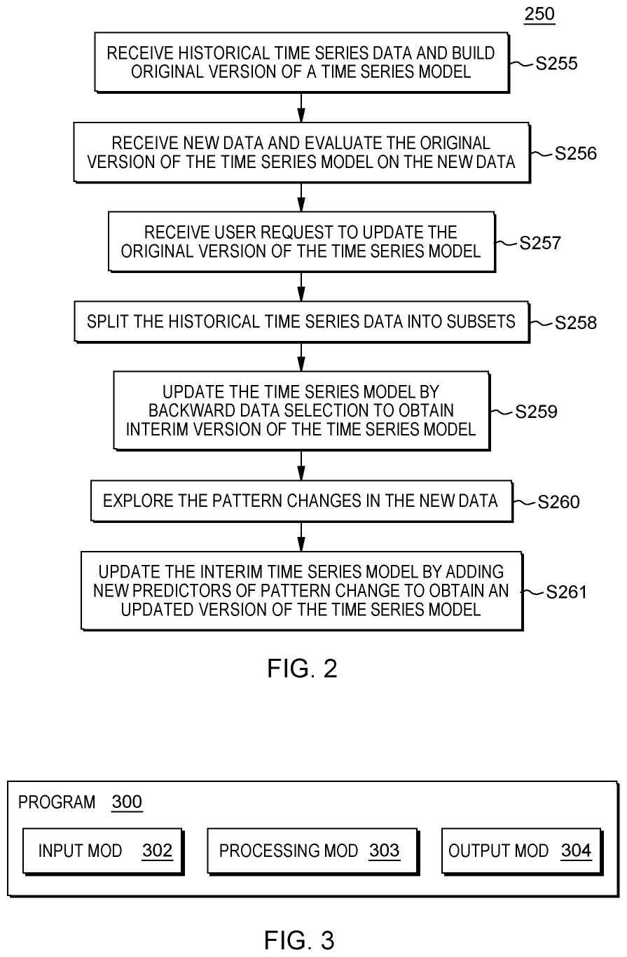

As shown in FIG. 2, flowchart 250 represents a computer implemented method according to the present invention. The various operations of flowchart 250 will respectively be discussed in the following paragraphs.

OPERATION S255: Historical time series data (received by input mod 302 of program 300 as shown in FIG. 3) and build time series model (original version is built by processing mod 303) will now be discussed. The time series data can be univariate time series or multivariate time series. There can be one or more than one targets series, and can be some predictors series. The time series model can be a statistical model, such as ARIMA (autoregressive integrated moving average) model, Exponential Smoothing model, or machine learning model such as xgboot, neural network which are built on transformed data from time series data.

OPERATION S256: Processing mod 303 evaluates the original version of the time series model. Using the time series model to predict values on the time periods of new data, which is received by input mod 302. Based on the ground truth of new data and predicted values, compute the accuracy measures. Examples of accuracy measure: MAE (mean absolute error), SMAPE (symmetric mean absolute percentage error), and RMPE (root square of mean percentage error). Processing mod 303 evaluates the original version of the time series model on the new data.

OPERATION S257: Input mod 302 receives a user request to update the original version of the time series model.

OPERATION S258: Processing mod 303 splits the historical time series into subsets by: (i) detecting the time series seasonality; and (ii) splitting the time series into subsets from latest to oldest, where each subset can have k seasons of time series, and further where k is a parameter value specified by the user.

OPERATION S259: Processing mod 303 updates the original version of the time series model by backward data selection by: (i) from the data subset W1 that is the closet to new data, time series is updated and evaluated on the new data; (ii) sequentially add one more data subset W2, W3, . . . (when each data subset is added, the model is needed to update and evaluate on the new data); (iii) when the model is updated, the model accuracy of the current model is compared with the previous model; (iv) if the current updated model is not better than the previous one, then stop; and (v) update the model by backward data selection to obtain an interim version of the time series model; and (v) when the process stops, the interim version of the time series model is obtained and the selected data that is used to make this update that is reflected in the interim version of the time series model.

OPERATION S260: Processing mod 303 explores the pattern changes on new data by: (i) computing the residuals on new data; (ii) exploring the new patterns of residuals to determine: (a) if there is strong correlation between residuals and a new exogenous variable, and (b) if there is a new trend or seasonality in residuals, and (c) if there are outliers such as level shift on the new data; and (iii) creating variables to indicate the time location of the pattern changes.

OPERATION S261: Processing mod 303 updates the interim version of the time series model by adding new predictors of pattern change, where new predictors include the new exogenous variable and newly created indicators. This includes updating the interim version of the time series model, to obtain an updated version of the time series model, uses selected data and new data, and takes the new predictors into consideration. The updated version of the time series model on selected data is represented by the following equation:

yₜ=f(yₜ₋₁, . . . ,yₜ₋ₚ;θ₁)

The new pattern on new data is represented by the following equation:

rₜ=g(rₜ₋₁, . . . ,rₜ₋ₘ,θ₂)*I(t)+h(xₜ₋₁, . . . ,xₜ₋ₗ;θ₃)

where g(⋅)*I(t) is the outlier function and I(t) is created new indicator of outlier, and h(⋅) are a function of new a exogenous variable, which leads to an equation representing the updated model:

yₜ=f(yₜ₋₁, . . . ,yₜ₋ₚ;θ₁′)+g(rₜ₋₁, . . . ,rₜ₋ₘ,θ₂′)*I(t)+h(xₜ₋₁, . . . ,xₜ₋ₗ;θ₃′)

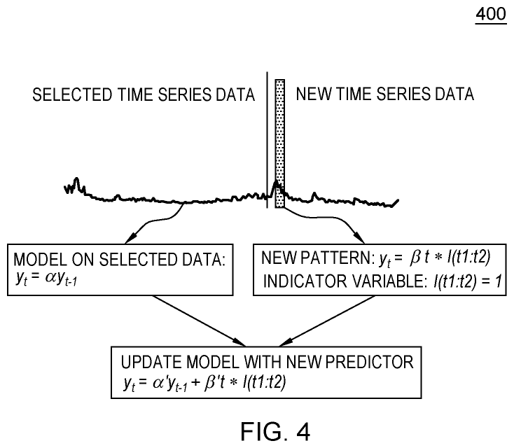

The updated version of the time series model is outputted, by output mod 304, to the various client subsystems 104, 106, 108, 110, 112. Now that the discussion of operations of flowchart 250 has come to a conclusion, diagram 400 of FIG. 4 will be discussed. The model on selected data is AR(1) model is as follows:

yₜ=αyₜ₋₁

There is a trend pattern from t=t1 to t2 on new data as follows:

rₜ=βt*I(t1:t2)

The updated version of the time series model combines the model on selected data and the new pattern on new data together with new parameter, α′ and β′. In the example, there is no new exogenous variable, so, it is as follows:

h(⋅)=0.

Some embodiments provide a system for time series model update that can help the user to select appropriate historical time series data. Some embodiments can detect the pattern changes in new data and take the changes into consideration when update model. Both the new exogenous variable and the created variable can be handled.

### III. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Including/include/includes: unless otherwise explicitly noted, means “including but not necessarily limited to.”

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

Set of thing(s): does not include the null set; “set of thing(s)” means that there exist at least one of the thing, and possibly more; for example, a set of computer(s) means at least one computer and possibly more.

Virtualized computing environments (VCEs): VCEs can be stored as “images.” A new active instance of the VCE can be instantiated from the image. Two types of VCEs are virtual machines and containers. A container is a VCE that uses operating-system-level virtualization. This refers to an operating system feature in which the kernel allows the existence of multiple isolated user-space instances, called containers. This isolated user-space instances may look like real computers from the point of view of programs running in them. A computer program running on an ordinary operating system can see all resources (connected devices, files and folders, network shares, CPU power, quantifiable hardware capabilities) of that computer. However, programs running inside a container can only see the container's contents and devices assigned to the container.

What is claimed is:

1. A computer-implemented method (CIM) comprising:
receiving an original version of a time series model;
receiving a historical time series data set including historically observed time series data;
receiving a new data set including new time series data;
splitting data of the historical time series data set into subsets;
updating the original version of the time series model by backwards data selection to obtain an interim version of the time series model;
exploring pattern changes in the new data to obtain new predictors of pattern change; and
updating the interim version of the time series model by applying the new predictors of pattern change to obtain an updated version of the time series model.

2. The CIM of claim 1 further comprising:
using the updated version of the time series model to predict values of newly incoming data in a time series data stream.

3. The CIM of claim 1 further comprising:
prior to updating the time series model by backwards data selection, building the original version of the time series model based on the historical time series data set.

4. The CIM of claim 3 further comprising:
prior to updating the time series model by backwards data selection, evaluating the original version of the time series model based on the new data set.

5. The CIM of claim 4 further comprising:
prior to updating the time series model by backwards data selection, receiving a user request to update the original version of the time series model.

6. The CIM of claim 1 further comprising:
handling, by the updated version of the time series model, a new exogenous variable and a created variable in newly received data of a time series data stream.

7. A computer program product (CPP) comprising:
a set of storage device(s); and
computer code stored collectively in the set of storage device(s), with the computer code including data and instructions to cause a processor(s) set to perform at least the following operations:
receiving an original version of a time series model;
receiving a historical time series data set including historically observed time series data;
receiving a new data set including new time series data;
splitting data of the historical time series data set into subsets;
updating the original version of the time series model by backwards data selection to obtain an interim version of the time series model;
exploring pattern changes in the new data to obtain new predictors of pattern change; and
updating the interim version of the time series model by applying the new predictors of pattern change to obtain an updated version of the time series model.

8. The CPP of claim 7 wherein the computer code further includes instructions for causing the processor(s) set to perform the following operation(s):
using the updated version of the time series model to predict values of newly incoming data in a time series data stream.

9. The CPP of claim 7 wherein the computer code further includes instructions for causing the processor(s) set to perform the following operation(s):
prior to updating the time series model by backwards data selection, building the original version of the time series model based on the historical time series data set.

10. The CPP of claim 9 wherein the computer code further includes instructions for causing the processor(s) set to perform the following operation(s):
prior to updating the time series model by backwards data selection, evaluating the original version of the time series model based on the new data set.

11. The CPP of claim 10 wherein the computer code further includes instructions for causing the processor(s) set to perform the following operation(s):
prior to updating the time series model by backwards data selection, receiving a user request to update the original version of the time series model.

12. The CPP of claim 7 wherein the computer code further includes instructions for causing the processor(s) set to perform the following operation(s):
handling, by the updated version of the time series model, a new exogenous variable and a created variable in newly received data of a time series data stream.

13. A computer system (CS) comprising:
a processor(s) set;
a set of storage device(s); and
computer code stored collectively in the set of storage device(s), with the computer code including data and instructions to cause the processor(s) set to perform at least the following operations:
receiving an original version of a time series model;
receiving a historical time series data set including historically observed time series data;
receiving a new data set including new time series data;
splitting data of the historical time series data set into subsets;
updating the original version of the time series model by backwards data selection to obtain an interim version of the time series model;
exploring pattern changes in the new data to obtain new predictors of pattern change; and
updating the interim version of the time series model by applying the new predictors of pattern change to obtain an updated version of the time series model.

14. The CS of claim 13 wherein the computer code further includes instructions for causing the processor(s) set to perform the following operation(s):
using the updated version of the time series model to predict values of newly incoming data in a time series data stream.

15. The CS of claim 13 wherein the computer code further includes instructions for causing the processor(s) set to perform the following operation(s):
prior to updating the time series model by backwards data selection, building the original version of the time series model based on the historical time series data set.

16. The CS of claim 15 wherein the computer code further includes instructions for causing the processor(s) set to perform the following operation(s):
prior to updating the time series model by backwards data selection, evaluating the original version of the time series model based on the new data set.

17. The CS of claim 16 wherein the computer code further includes instructions for causing the processor(s) set to perform the following operation(s):
prior to updating the time series model by backwards data selection, receiving a user request to update the original version of the time series model.

18. The CS of claim 13 wherein the computer code further includes instructions for causing the processor(s) set to perform the following operation(s):
handling, by the updated version of the time series model, a new exogenous variable and a created variable in newly received data of a time series data stream.
